(19) United States
(12) Patent Application Publication
(10) Pub. No.: US 2010/0140177 A1
(43) Pub. Date: Jun. 10, 2010

(54) FLUID PROCESSING SYSTEM

(75) Inventors: Wolfgang Diemer, Waldstetten (DE); Martin Zeiler, Schwaebisch Gmuend (DE); Klaus Feifel, Schwaebisch Gmuend (DE)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, Port Washington, NY (US)

(21) Appl. No.: 12/526,533

(22) PCT Filed: Feb. 1, 2008
(86) PCT No.: PCT/EP08/00804

§ 371 Date: Feb. 3, 2010

Related U.S. Application Data
(60) Provisional application No. 60/889,755, filed on Feb. 14, 2007.

(51) Int. Cl. B01D 25/12; B01D 15/04

(52) U.S. Cl. 210/663; 210/343; 210/255; 210/247; 210/314; 210/231; 210/226; 210/806; 210/757; 210/749

(57) ABSTRACT

A fluid processing system comprising a housing (12) and at least one of a first type and at least one of a second type module, (25-28), The first and second modules having different fluid processing characteristics each module comprising a body of wound layers of a sheet material, said body having an inner and an outer peripheral surface, a first and a second end face, a passage (42, 44) extending along the winding axis of said body and in fluid communication with said inner peripheral surface, the passage of one of the first type and one of the second type modules being closed at one end thereof, said sheet material having a plurality of openings formed therein, said openings forming a first and a second type of channels within the wound layers of sheet material of said body, extending in a direction from the inner peripheral surface to the outer peripheral surface, the first type of channels being open at one end at said outer peripheral surface of the body and closed at the other end located adjacent to said inner peripheral surface, the second type of channels being open and closed at the respective other ends or closed at both ends, said channels of the one type being separated from the channels of the other type by portions of sheet material.

### FIELD OF THE INVENTION

The present invention relates to a fluid treatment system useful in the multi-step processing of fluids, especially liquids, e.g. beverages or food oils.

### BACKGROUND OF THE INVENTION

In many filtration applications, production and cleaning processes different process steps, especially different filtering steps are required.

These steps are traditionally carried out separately, performing one step after the other. This is especially true for filtration processes, where the successful performance of the first filtration step is a prerequisite for the beginning of the second filtration step.

This necessary sequence of steps quite often results in a process layout where each filtration step has its own design, starting from an own housing for the filter media, up to separate pumps and associated equipment and ending up possibly even in separate cleaning processes for the filtration equipment. This is especially true when so called closed systems are to be used.

Associated with these problems are high investment costs, long process times, additional costs for storage of equipment, product losses due to additional dead volume and additional cleaning costs, to name only the most important disadvantages.

### SUMMARY OF THE INVENTION

In order to provide an efficient multi-process equipment, the invention proposes a fluid, processing system including two or more treatment modules accommodated in one housing.

The invention especially relates to a fluid processing system comprising a housing and at least one of a first and at least one of a second module, said first and second modules each comprising a body of wound layers of a sheet material. The body of each module has an inner and an outer peripheral surface, a first and a second end face, a winding axis and a passage extending along the winding axis of said body and in fluid communication with said inner peripheral surface, the passage of one of the first and one of the second filter modules being closed at one end thereof. The sheet material of said body has a plurality of openings formed therein, said openings forming at least two types of channels within the wound layers of sheet material of said body.

The channels extend in a direction from the inner peripheral surface to the outer peripheral surface, whereas a first type of channels is open at one end at said outer or said inner peripheral surface of the body and closed at the other end located adjacent to said inner peripheral surface, and a second type of channels is open and closed at the respective other end located adjacent to said inner peripheral or outer peripheral surface of the body or closed at both ends thereof, said channels of the one type being separated from the channels of the other type by portions of sheet material.

The first and second modules have different processing, e.g. filtering, characteristics.

The housing is provided with an inlet port and an outlet port and accommodates said first and second modules. Said inlet port is in fluid communication with the end faces of the body and/or one type of channels of the first type of module serving as inlet channels. The other type of channels of the first type filter module serve as outlet channels.

Said outlet port of the housing communicates with one type of channels of the second type module serving as outlet channels and/or the end faces of the body. The other type of channels of the second type module serve as inlet channels and are in fluid communication with said outlet channels of the first type modules.

The present invention advantageously makes use of modules which comprise a body of wound layers of a sheet material. Such modules are easily used with a fluid flow direction from the outer peripheral surface to the inner peripheral surface as well as a fluid flow direction from the inner peripheral surface to the outer peripheral surface. Backwashing of the modules and the system as a whole is greatly facilitated.

The modules to be used in the system of the present invention provide in addition a higher filtration capacity as compared to other type of modules without occupying additional space. Therefore, advantageously existing systems may be easily upgraded with respect to their processing/filtration capacity and/or service life.

Newly designed systems may take advantage of the small foot print of the modules allowing for a compact design of the system as whole.

Since the modules may be selected to perform more than one processing tasks in one step, the system may be designed in a more simple manner avoiding extensive tubing and multiple safety devices like safety valves.

In addition, cleaning operations require less cleaning fluid and less energy. The cleaning operation as a whole is simplified.

The system of the present invention allows to minimize dead volume making processing of fluids and the cleaning operation more cost effective. At the same time hold up volume is minimized.

Furthermore, the bodies of wound layers, in the following also called wrap rolls, may be easily modified to be adapted to different processing tasks, especially filtration tasks. In the processing system of the present invention each type of module, i.e., the first and second and optionally any further type of module, performs its own separation or processing task or tasks.

It is pointed out that multiple modules of the same type may be used in the same system, i.e., in the same housing.

Typical fluid processing applications include but are not limited to ion exchange treatment, redox reactions, catalytic reactions, pH adjustment, all type of separation treatments including adsorption, absorption and filtration processes.

Many fluid processing applications include at one or more stages of the processing a filtration step.

For a specific filtration application, the first module may be included in the housing twice and serve for coarse filtration, whereas the second type module is present only once in the housing and is responsible for fine filtration.

Depending on the particle load of coarse and fine particles of the fluid to be filtered, of course also only one module of the first module type and two modules of the second module type may be used.

Furthermore, it is readily appreciated that any number of first, second and also any further type of modules may be included in one housing, the number of which are easily adapted to the specific processing or filtration task and the fluid and its contaminants to be treated or the process to be performed.

In its simplest configuration, the inventive fluid processing system includes two types of modules, namely a first and a second module, where one or more modules of the first type and one or more modules of the second type may be accommodated in the housing, e.g., in one common compartment.

In such a configuration the non-filtrate may be fed through the inlet port of the housing into an open end of the passage of the first type of modules which is bounded by the inner peripheral surface of the body of the wrap roll thereof.

The other end of the passage is either in fluid communication with an open end of the successive filter module of the first type or if only one module is used, it will be blocked.

If further modules are to be used, at least the last one in the sequence of the first type of the modules will have a passage which is blocked at one end thereof. The other end of the passage will be connected to a passage of a preceding module of the first type.

The volume adjacent to the outer peripheral surface of the first type of modules receives a first filtrate from the first type of modules. This volume will at the same time serve as the volume holding the non-filtrate for the second type of module and the fluid flow will be from the outer peripheral surface to the inner peripheral surface of the second module type.

Again, the second modules will have a passage which is closed at one end thereof, the other end of the passage being in fluid flow communication with the outlet port of the housing, either directly or mediated by one or more passages of one or more modules of the second type, respectively.

From the foregoing, it is apparent that the inventive fluid processing system may be easily adapted to an increased processing and/or filtration capacity in each one of the two (or more) processing/filtration steps to be performed by the system for a specific fluid and all the capacity of the system as a whole may be adapted to the quantity of fluid to be processed and filtered, respectively.

The filtrate received from the second type modules will be collected in the passage of the second type modules and be discharged via the outlet port of the housing.

For a number of applications the system of the present invention advantageously comprises at least one third module, said third module comprising a body of wound layers of a sheet material similar to the bodies of the first and second type of modules, the third module having processing characteristics which differ from the processing characteristics of the first and second modules, the passage of the third module being closed at one end thereof, said third module being encased in a fluid tight casing having an inlet and an outlet communicating with the inlet and outlet channels of the body of the third filter module, respectively.

The third module may be of the first or second or of a third type.

The modules of the system according to the present invention are preferably accommodated in the housing in stack form, the passages of the modules being aligned and in parallel to the longitudinal axis of the housing.

In between stacked modules it is preferred to position an intermediate plate to support the end faces of the modules while not necessarily blocking them.

The inventive use of the wrap rolls in the inventive system is of specific advantage since processing, e.g. filtration, may be performed both in forward and backward direction through the wrap roll modules. This is not only a feature which allows easy adaptation of the system to various filtration and processing tasks, but also allows in a reliable manner numerous regeneration processes without the fear of changing the filtration characteristics of the wrap rolls.

Blocking of one end of one of said first and second modules may be easily achieved by a separation plate and such separation plate may be even in common for a first and a second filter module. The separation plate may at the same time adopt the function of an intermediate plate.

In the alternative, encased wrap rolls may be used and such type of wrap rolls are needed when a third module type is used within the inventive fluid processing system.

Here, the wrap roll itself provides a compartment which allows isolation of the wrap roll against the other modules such that the third type of module may be placed in the same housing without providing an extra compartment in the housing.

In such case, for example, a third module will receive in its passage the filtrate from the passage from the second type module, the fluid will pass from the inner peripheral surface outwards to the outer peripheral surface of the third module and be collected within the fluid tight casing and then discharged via the outlet port of the housing.

However, also in cases where only a first and a second type of filter modules are used, encased wrap rolls may be used.

It is easily understood that also from the encased type of modules more than one module may be combined in order to increase the processing/filtration capacity and/or throughput of the system.

The use of deflection plates between two stacked modules provide for redirection of the fluid flow, collecting fluid from the outer periphery of one module and directing the flow into the passage of the neighboring module. At the same time, the deflection plate can adopt the function of an intermediate plate.

The difference in processing and filtration characteristics, respectively, from one type of modules to the other may be obtained by using a sheet material for the first and second (and optionally any further (type of) module) which have a different processing/filtration characteristic.

The sheet material of body may be a depth filter material or may be a non-porous material depending on whether the module is to work as a depth filter unit or a surface filter unit or a treatment module.

Most of the depth filter materials useful in the present invention may be compressed or deformed. The portion of deformation, which is permanent, differs depending on the depth filter material used.

Preferably, the depth filter material is not only plastically or permanently deformable, but at least partly shows elastic properties so that upon compression of the sheet material, the elastic portion of the deformation helps to keep the adjacent layers of sheet material in close contact with one another, even if the surface of the sheet material may in its original state not be perfectly planar.

The sheet material used to produce the wrap rolls may also contain or incorporate treatment material which may be used in processing of the fluid.

Furthermore, or alternatively, the sheet material of the first and second type of modules and optionally of any further module, may be compressed to a different extent and the bodies of the wound layers of sheet material may be then kept in a different state of compression.

According to this embodiment, the identical type of compressible sheet material may be used which, when it is compressed to a different extent in the various types of modules result in different filtration characteristics of the module bodies.

Furthermore, the modules of the present invention may be provided with different processing and/or filtering characteristics or processing characteristics by a precoating of one or more of the different modules.

Precoating can be used in order to further modify the filtration characteristics and/or processing characteristics of the module.

For example, precoating may be used to provide a module with adsorptive sites for polyphenol and/or protein adsorption which are needed, for example, in the stabilization of a number of beverages like beer and wine.

The present invention furthermore encompasses a method of processing a fluid, such method making use of a fluid processing system as described above. The fluid is supplied to the inlet port of the housing and the filtrate is discharged from the outlet port of the housing.

In such method, processing can mean filtration or any other type of modification of the fluid to be filtered, depending on the processing characteristics of the modules used.

In one specific method of the present invention, the method comprises a coarse filtration step and a fine filtration step. It is noted that these coarse and fine filtration steps are performed at the same time in one housing only such that the regeneration of the filtration modules used for the coarse and fine filtration may be regenerated in one regeneration step only.

In another embodiment of the present invention, the method comprises a filtration step and a stabilization treatment step, especially by removing polyphenols and/or proteins from the fluid to be processed.

The foregoing advantages and further advantages may be apparent from the following description of the Examples and the Figures.

### BRIEF DESCRIPTION OF THE DRAWINGS

FIG. 1: a schematic illustration of a fluid processing system according to a first embodiment of the present invention;

FIG. 2: the system of FIG. 1 with inverse flow direction;

FIG. 3: a schematic illustration of a fluid processing system according to a second embodiment of the present invention;

FIG. 4: a schematic representation of a module for use in a system according to FIG. 1 through 3;

FIG. 5: the module of FIG. 4 with part of the body cut away;

FIG. 6: a cross-sectional representation of a module for use in a system according to FIG. 1 through 3;

FIG. 7: a partial cross-sectional representation of a module for use in a system according to FIG. 1 through 3; and

FIG. 8: a partial cross-sectional representation of a module for use in a system according to FIG. 1 through 3.

### DETAILED DESCRIPTION OF THE INVENTION

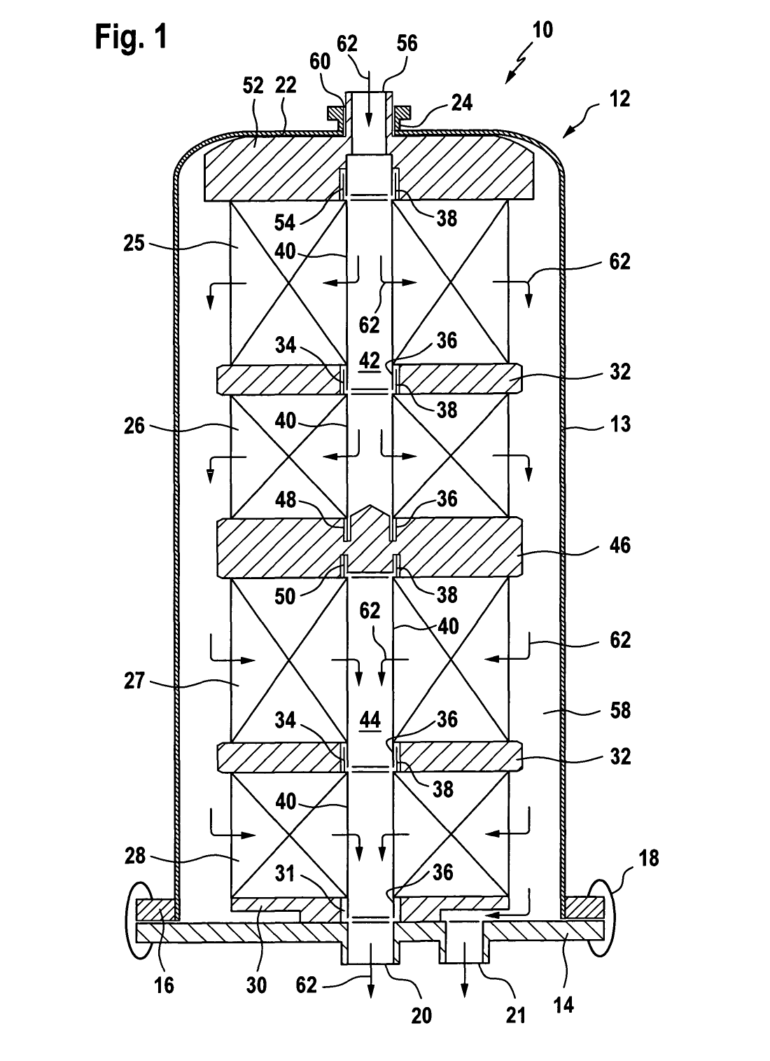

FIG. 1 shows a modular fluid processing system 10 comprising a cylindrical housing 12 in which four modules 25, 26, 27, 28 are accommodated one above another. The housing 12 with a cylindrical wall 13 comprises a bottom plate 14 which closes the lower open end of the cylindrical wall 13. The cylindrical wall 13 comprises at its lower open end a radially outwardly extending flange 16 to which the bottom plate 14 is connected by connecting means 18, for example, clamping screws, in a pressure-tight manner. At the center of the bottom plate 14 a central opening 20 and an off-center opening 21 are provided which are configured as line connectors and, depending on the flow direction, can serve as an inlet for the unprocessed fluid or an outlet for the processed fluid, respectively.

At the upper end of the cylindrical wall 13 of the housing 12 a top wall 22 is provided which closes the housing 12 at its upper end and is preferably integrally formed with the cylindrical wall 13. The center of top wall 22 comprises a socket 24 providing access to the interior of housing 12.

Within the housing 12 the modules 25, 26, 27 and 28 are accommodated in the form of a stack. The module 28 in the lowest position of the stack is supported by an adapter plate 30. The module rests with one of its end faces against the adapter plate 30. The adapter plate 30 is provided with a central opening 31 which sealingly receives the lower end portion 36 of module 28. In between the individual modules 28 and 27 an intermediate plate 32 is provided which receives in its central opening 34 in an overlapping manner end portions 36, 38 of two adjacent modules 27 and 28. The end portions 36 having a somewhat narrower outer diameter as compared to the inner diameter of end portions 38. A further intermediate plate 32 is positioned in the same manner between modules 25 and 26.

The intermediate plates 32 arranged between the filter modules 25 and 26 and the filter modules 27 and 28 support the modules 25 and 27. The upper and lower surfaces of the intermediate plates 32 may be provided with a structure which supports the respective end face of a module but nevertheless maintains fluid communication of the end face with the outer periphery of the module.

The modules 25, 26, 27 and 28 are made of a multiplicity of windings of sheet material around a central passage which is preferably defined by a hollow cylindrical support element 40. The support elements 40 are preferably formed as a unitary structure with end portions 36, 38.

The support elements 40 of modules 25, 26 form a passage 42, whereas the support elements 40 of modules 27, 28 provide a passage 44, both passages being in line with one another and arranged in the center of housing 12.

The two passages 42 and 44 are, however, not in direct fluid communication since in between modules 26 and 27 a partition plate 46 is positioned, which receives end portions 36 of module 26 and end portion 38 of module 27 in ring shaped recesses 48 and 50. The upper and lower surfaces of the partition plate 46 may be designed to support the end faces of the adjacent modules similar to the intermediate plates 32.

The ring shaped recesses 48 and 50 are provided in an upper and lower surface of partition plate 46, respectively, and are separated by a non-pervious portion of partition plate 46.

On top of the stack of the four modules 25, 26, 27 and 28 a top plate 52 is provided having a central opening 54 on its lower surface to receive and support an end portion 38 of the upper most module 25. On its upper surface the top plate 52 comprises a central tubular element 56, which directly communicates with opening 54 and extends through socket 24 of the top wall 22 of the housing 12.

The modules 25, 26, 27, 28, depending on the processing application, can be made of different materials which may include filtering aids.

The support elements 40 of the modules 25 and 26 provide the central passage 42 or a first chamber. Between the exterior surface of the modules 25, 26, 27, 28 and the housing 12 a ring shaped second chamber 58 is formed. The two filter modules 27 and 28 form a third chamber or passage 44.

In the top plate 52 a vent 60 is provided which establishes a fluid flow connection between the second camber 58 and the exterior of the housing 12 and is embodied, for example, as a channel which extends along the top side of the top plate 52 and exits at the container socket 24. Between the first chamber 42 and the third chamber 44, partition plate 46 blocks fluid flow.

The opening 21 serves for completely emptying the housing 12 and is also embodied as a line connector.

The interior passages 42, 44 of the filter modules 25, 26, 27, 28 are sealed relative to the exterior of the modules, i.e., the second chamber 58.

The arrows 62 illustrate the flow direction of a fluid through the system 10 in FIG. 1. The tubular element 56 which is embodied as a line connector, forms the inlet through which the unprocessed fluid flows into the first chamber (passage) 42 which is formed within the two modules 25 and 26. From here, the fluid flows through the modules 25 and 26 into the second chamber 58 in a first processing stage. This pre-processed fluid can be removed via the opening 21, for example, for monitoring purposes. The pre-processed fluid otherwise further flows from the second chamber 58 through the modules 27 and 28 into the third chamber 44 in a second processing stage. The final processed fluid collected in the third chamber 44 exits the system 10 through the opening 20 which is embodied as a line connector and serves as an outlet. In this arrangement the modules 25 and 26 have a flow direction from the interior to the exterior, and the modules 27 and 28 have a flow direction from the exterior to the interior.

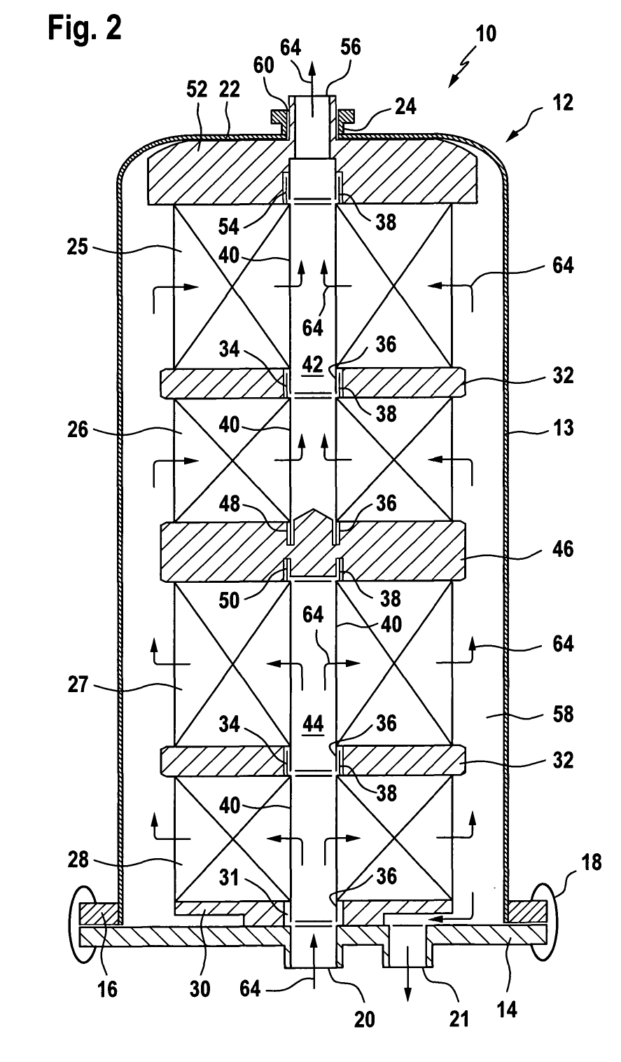

In FIG. 2 the system 10 of FIG. 1 is illustrated with a second possible flow pattern which is illustrated by the arrows 64, wherein in FIGS. 1 and 2 identical reference numerals identify identical parts. The unprocessed fluid flows through the opening 20 which functions as an inlet into the chamber 44. From the chamber 44 it passes through the modules 27 and 28 into the chamber 58 in a first processing stage thereby generates a pre-processed fluid which can be removed through the opening 21. The pre-processed fluid flows from second chamber 58 through the modules 25 and 26 into the chamber 42 from where it exits the system 10 as a final processed fluid through the opening 56 which serves as an outlet. In this flow direction, the modules 25 and 26 have a fluid flow direction from the exterior to the interior and the filter modules 27 and 28 have a flow direction from the interior to the exterior.

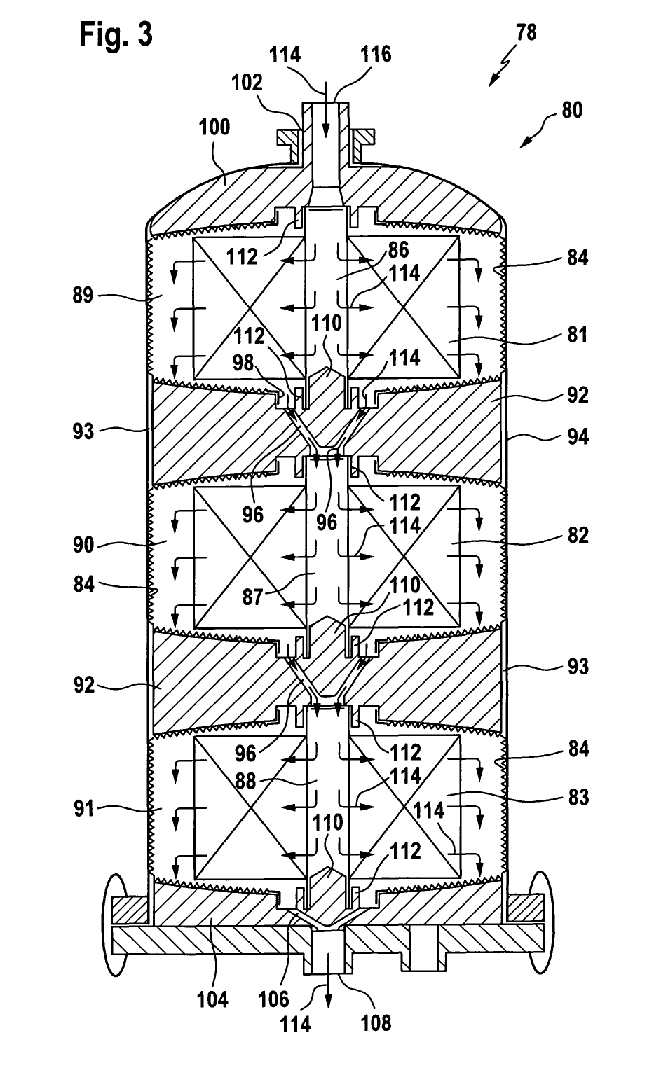

In FIG. 3 a system 78 comprising in a housing 80 three modules 81, 82, 83 is illustrated. The housing 80 may be of a design similar to housing 12 of the embodiment of FIGS. 1 and 2. The filter modules 81, 82, 83 are each accommodated in a separate encapsulation 84 which is comprised of a flexible, expandable material and encapsulates the exterior surface of the modules 81, 82, 83 relative to the surroundings. Each module 81, 82, 83 comprises an inner passage 86, 87, 88 or chamber and an exterior chamber 89, 90, 91 delimited by the exterior side of the modules and the respective encapsulation 84.

The encapsulation 84 can be embodied, for example, as a film bag.

Between the filter modules 81 and 82 and the filter modules 82 and 83, respectively, a deflection plate 92 is arranged, which supports the modules 81 and 82. The exterior surfaces of the deflection plate 92 extending essentially perpendicularly to the longitudinal axis of the housing 80 are concave in order to provide good support surfaces for the encapsulation 84. An annular gap 93 which is formed between the cylindrical wall 94 of housing 80 and the deflection plate 92 is so narrow that the encapsulation 84 cannot project significantly into the annular gap 93 so that damage to the encapsulation 84 is prevented. The deflection plate 92 has deflection channels 96 which form a fluid flow connection with an annular gap 98 arranged underneath the module 81 as a part of the exterior chamber 89 of the module 81 and the inner chamber (passage) 86 of the module 82.

In the system 78 a total of four chambers is formed, wherein a first chamber is formed by the inner chamber (passage) 86 of the filter module 81; the second chamber by the outer chamber 89 of the filter module 81, the fluid flow connection formed by the deflection channels 96, and the interior chamber (passage) 87 of the filter module 82; the third chamber is provided by the exterior chamber 90 of the filter module 82 and the inner chamber (passage) 88 of the filter module 83; and the fourth chamber by the exterior chamber 91 of the filter module 83.

Between the deflection plate 92 and the portion of the central passage of the modules 81, 82, 83, a seal is provided which seals the interior chamber relative to the respective exterior chamber. The portions of the passages projecting past the filter modules 81, 82, 83 are configured to have the same diameter as the central portion of the passage itself. Seals are further provided to seal the exterior chamber formed by the encapsulation 84 relative to the interior of the housing 94. For example, sealing rings can be provided as the seal in order to provide a sealing action.

On top of the stack of modules 81, 82, 83, a top plate 100 is positioned which has a concavely formed underside. Between the head plate 100 and the container housing 94 a narrow annular gap is formed which enables removal of the top plate 100 from the housing 80 and, at the same time, prevents inward curving of the encapsulation 84 into the annular gap. A vent 102 is provided in the top plate 100 which realizes a fluid flow connection between the interior of the housing 94 and the exterior of the system.

An adapter plate 104 is arranged at the bottom of the module stack which has a concave top side and deflection channels 106 connect the fourth chamber 91 with an opening 108 provided in the container bottom, wherein the opening 108 serves as an outlet for the final processed fluid. The adapter plate 104 serves for supporting the filter module 83.

In the center of the top sides of the adapter plate 104 and the deflection plates 92 a guide element 110 is arranged which guides and centers the filter modules 81, 82, 83 when assembling same to form a stack. On the top sides of the adapter plate 104 and the deflection plates 92 and on the undersides of the top plate 100 and the deflection plates 92, respectively, guide rings 112 are formed, which serve for guiding and centering the exterior parts of the passages of the modules as well as for sealing the interior chamber (passages) of the filter modules relative to the exterior chambers of the filter modules. The guide rings 112 can also serve as a retaining means for a sealing element arranged between them and the central passages of the modules.

The arrows 114 illustrate the flow direction of a fluid through the system 78. The unprocessed fluid flows through an opening 116, arranged in the upper portion of the housing 80 and functioning as an inlet, into the first chamber 86, from there through the module 81 into the second chamber 89 in a first processing step. The pre-processed fluid flows from there through the deflection channels 96 in the deflection plate 92 into the central channel (passage) 87 of the filter module 82. In the second processing step, the fluid flows through the module 82 and forms a further processed fluid which is collected in chamber 90. Via the deflection channels 96 the fluid reaches the interior chamber (passage) 88 of the module 83 from where it passes in a third processing step the module 83. The then finally processed fluid is collected in chamber 91 and exits the system 78 via the adapter plate 104 and the opening 108 which functions as an outlet. The flow direction of a fluid can also be effected in an inverse direction.

The modules 81, 82 and 83 can be provided as filter modules. In a preferred embodiment the modules can be comprised of different filter materials and can in addition be filled with filtering aids. Different combinations of the modules, including combinations of encapsulated with non-encapsulated modules, are possible with a corresponding configuration of the partition plates, intermediate plates, deflection plates, top plates, and adapter plates.

One module can provide pre-filtration, and one filtration for sterile filtration can be effected in a further module of the inventive processing system. When utilizing filled modules, a module filled with activated charcoal, in particular, in combination with a filtration stage which uses a filter module for depth filtration can be expedient. Also, other adsorptive materials can be advantageous for filling a module. A filling with diatomite can be expedient for different processing, e.g., filtration purposes, in particular, the combination of a module filled with coarse diatomite for pre-filtration and a module filled with fine diatomite for fine filtration.

The individual processing modules used in the systems described in connection with FIGS. 1 and 2 and 3, respectively, have not yet been described in detail.

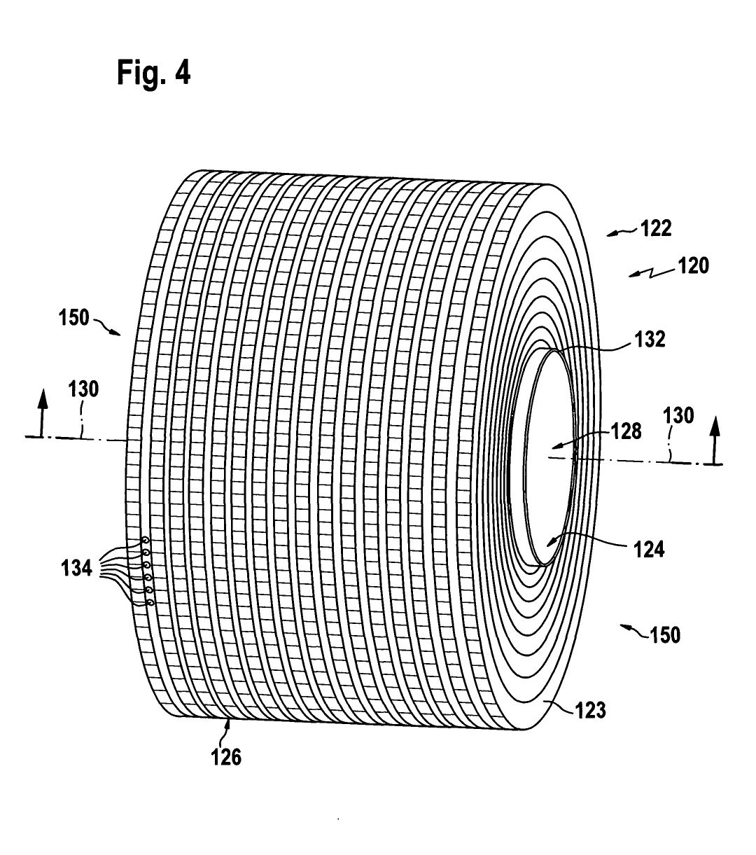

In the following typical examples of advantageous modules which may be used as part of the inventive processing system will be described with reference to FIGS. 4 to 8.

FIG. 4 shows a module 120, comprising a body 122 of wound layers of a sheet material 123.

The body 122 of module 120 comprises an inner peripheral surface 124 and an outer peripheral surface 126. Within the body 122 there is a passage 128 which extends through the body 122 along its winding axis 130, coextensive with the inner peripheral surface of the body. The inner peripheral surface of the body is in fluid communication with the passage which is constituted in the embodiment of FIG. 4 by a support member 132 in the form of a hollow, perforated shaft (not shown in detail in FIG. 4).

The sheet material 123 comprises a large number of openings 134 which in case of the embodiment shown in FIG. 4 are of circular shape, cooperating to form a first type of channel 136 which opens to the outer peripheral surface 126. Channels 136 generally extend in the direction from the outer to the inner peripheral surface of the body 122.

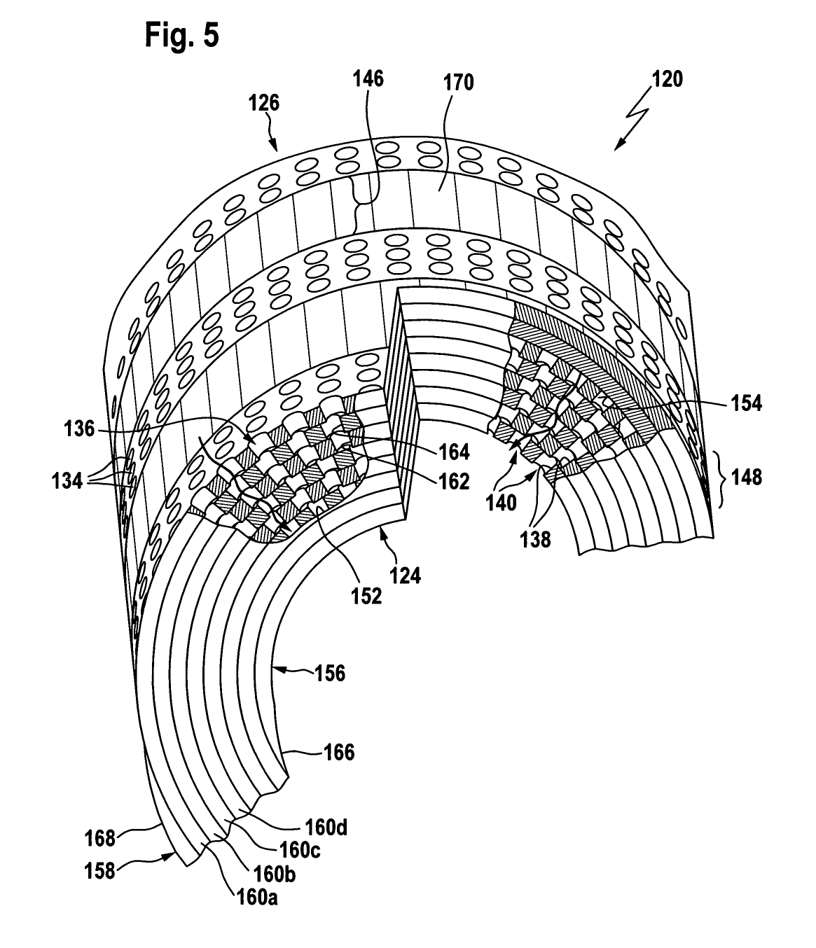

The sheet material 123 furthermore comprises a plurality of openings 138, cooperating to form a second type of channels 140 which open to the inner peripheral surface 124 of the body 122 (cf. FIG. 5). Channels 140 generally extend in the direction from the inner to the outer peripheral surface of body 122.

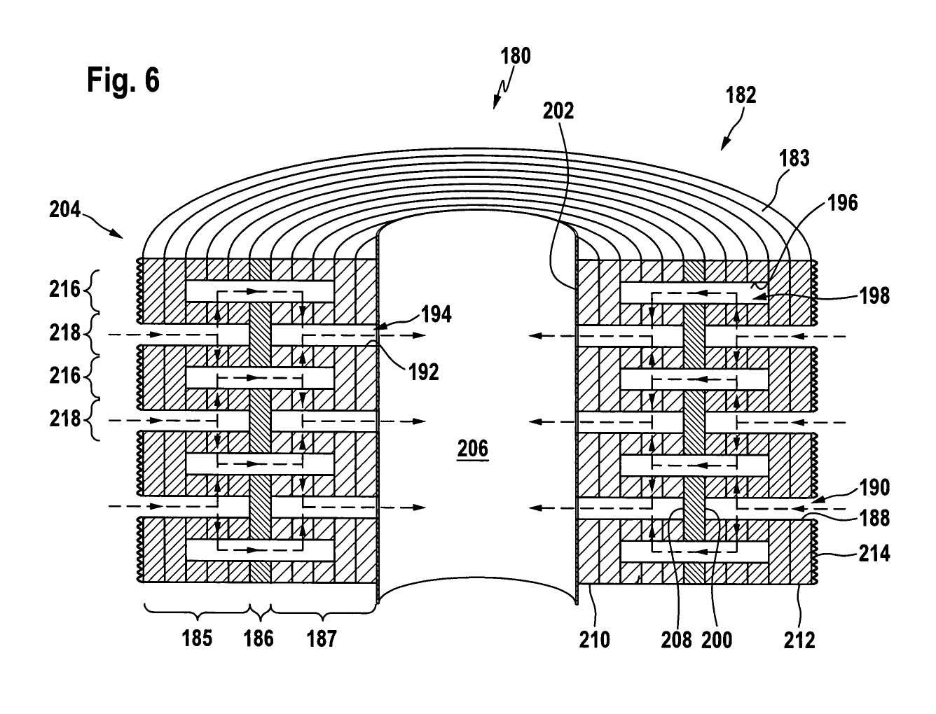

A third type of channels may be provided by registering openings (cf. FIG. 6). These channels extend in radial directions of body and are closed at both ends thereof. The third type of channels will in numerous applications hold a particulate treatment material, but in other cases just receive the fluid from the inlet channels, allow the fluid to redistribute and pass on to the outlet channels.

For ease of reference, the first type of channels 136 will be called inlet channels, the second type of channels 140 will be called outlet channels. The third type of channels will be called treatment channels.

It has, however, to be noted that it is within the scope of the present invention that the channels 136 which open to the outer peripheral surface 126 may function as outlet channels, whereas the channels 140 which open to the inner peripheral surface 124 than serve as inlet channels. The fluid flow would then be reversed from passage 128 into channels 140, through the body 122 of sheet material 123 optionally to the treatment channels and from there to the channels 134 collecting the filtrate and draining it to the outer peripheral surface 126. Also the treatment channels may not necessarily hold any treatment material as noted above.

Fluid ingress into (or drainage from) the module may also be provided via the end faces 150 of module 120.

Preferably, the openings 134, 138 are arranged in the sheet material 123 in parallel rows so that the inlet and outlet channels 136 and 140, and optionally the treatment channels, respectively, are formed in separate disk shaped portions 140 and 148 of the body 122.

From FIG. 5 it is apparent that the openings 134 forming inlet channels 136, incompletely register with a corresponding opening 134 of an adjacent layer of sheet material 123.

The inlet channels 136 are closed on their ends 152, located adjacent to the inner peripheral surface 124 of body 122 and not in communication with said passage 128. Correspondingly, the outlet channels 140 are open at their ends adjacent to the inner peripheral surface 124, but are closed at their opposite ends 154 adjacent to outer peripheral surface 126. In order to provide this structure of channels 136 and 140 in the body 122 of the filter module 120, the sheet material 123 comprises in a first end portion 156 openings 138 only which contribute to forming the outlet channels 140. No openings which could contribute to forming inlet channels 136 are found in that portion 156 of sheet material 123.

At its other end portion 158, the sheet material 123 comprises openings 134 only contributing to form inlet channels 136, and in that end portion 158 no openings 138 which contribute to forming outlet channels 140 are found.

Usually, the lengths of the end portions 156 and 158 are such that the closed ends 152 and 154 of the inlet and outlet channels, respectively, are covered and shut off by at least two consecutive layers of sheet material 123 within the body 122 adjacent to the inner peripheral surface 124 and the outer peripheral surface 126, respectively.

This is usually enough to ensure that the processing, e.g., filtering characteristic of the body 122 as a whole is maintained and no fluid to be treated may bypass the sheet material and find a shortcut from the inlet of the module 120 to the outlet of the module.

As mentioned before, FIG. 5 shows the openings 134 of adjacent layers 160a, 160b, 160c and 160d incompletely register such that the surface of inlet channel 136 does not show a smooth tubular surface but comprises the plurality of recesses 162 and projections 164, respectively, increasing the surface area of the inlet channels 136 to a great extent, thereby increasing the filter capacity and the service life of the filter module 120. In processing applications other than filtration the increase of surface area may be of minor importance.

Likewise apparent from FIG. 5 is the gradually reduced thickness of the end portion 156 of the sheet material 123 at its very end, which may likewise be true for the end portion 158 at the outer peripheral surface 126 of body 122.

By having the end portions 156 and 158 with tapered sections 166 and 168, respectively, a smooth winding of the sheet material 123 is provided which contributes to a full contact of adjacent layers of sheet material 123 throughout the body 122.

The tapered portion 168 of end portion 158 of the sheet material 123 at the outer peripheral surface 126 of body 122 provides for a smooth outer surface 126, not comprising any step-like recesses on that surface.

This is of importance, once the body 122 of the module 120 is hold in compression by strip-like elements 170 which serve to keep the sheet material 123 of body 122, and therefore the body 122 as a whole, in a compressed state such that bypasses from inlet channels 136 to outlet channels 140 are avoided.

The strip-like elements 170 function as compression means and are positioned on the outer peripheral surface 126 of body 122 on such disk shaped portions 146 of the body 122 which comprise the outlet channels 140. The portion 148 of the body 122 comprising the inlet channels 136 are not covered by these strip-like elements 170. Therefore the compression of the body 122 in the areas 146 comprising the outlet channels 140 is somewhat higher than in the portions 148 of body 122 accommodating the inlet channels 136. This is of some importance for avoiding bypass problems, and the fluid to be processed is forced to migrate through the sheet material 123 prior to reach the outlet channels 140 and the passage 128.

The tapered end portion 168 of the end portion 158 of the sheet material 123 helps to apply the compression force of the strip-like elements 170 around the whole outer peripheral surface 126 in an even fashion which makes sure that the body 122 has homogenous processing, e.g., filtering characteristics throughout the whole body.

In case of the specific embodiment of an inventive module 180 shown in FIG. 6, a body 182 of windings of sheet material is roughly divided in three cylindrical portions 185, 186 and 187. The outer cylindrical portion 185 of body 182 is made of one first sheet material 183 and accommodates openings 188 forming inlet channels 190. The innermost cylindrical portion 187 of body 182 accommodates openings 192 forming outlet channels 194.

In between these two cylindrical portions, there is one third portion 186 which is an intermediate portion to separate the two portions 185 and 187 of body 182 accommodating the inlet and outlet channels. The sheet material making up for the third portion 186 has only openings 196 forming treatment channels 198 but no openings to contribute to inlet or outlet channels 190, 194. This portion of sheet material may be comprised of a fluid impervious material. In this case one layer (winding) will be sufficient.

In the alternative, the cylindrical portion 186 may be constituted of several layers of the second sheet material which also makes up for the portion 187 of the body 182. The number of layers required in portion 186 is dependent on the fluid flow resistance it provides to the fluid in radial direction of the body 182 which must be such that no direct flow from the inlet channels 190 to the outlet channels 194 may occur.

The inlet channels 190 are closed at their ends 200, located towards the inner peripheral surface 202 of body 182 and not in communication with said passage 206. Correspondingly, the outlet channels 194 are open at their ends adjacent to the inner peripheral surface 202, but are closed at their opposite ends 208 towards the outer peripheral surface 204. The third type of channels 198 is closed at both ends thereof. In order to provide this structure of channels 190, 194 and 198 in the body 182 of the module 180, the sheet material comprises in a first end portion 210 openings 192 only which contribute to forming the outlet channels 194. No openings which could contribute to forming treatment channels 198 are found in that portion 210 of sheet material.

At its other end portion 212, the sheet material comprises only openings 188 contributing to form inlet channels 190, and in that end portion 212 no openings 196 are found which contribute to forming treatment channels 198.

Usually, the length of the end portions 210 and 212 are such that the closed ends of the treatment channels are covered and shut off by at least two consecutive layers of sheet material within the body 182 adjacent to the inner peripheral surface 202 and the outer peripheral surface 204, respectively.

This is usually enough to ensure that the fluid flow characteristic of the body 182 as a whole is maintained and no fluid to be treated may bypass the sheet material and find a shortcut from the inlet of the module 180 to the outlet of the module.

In a preferred embodiment as shown in FIG. 6, the inner cylindrical portion 187 (optionally also the intermediate portion 186) of body 182 is made of a sheet material which has a different filter characteristic from the sheet material used for manufacturing the outer cylindrical portion 185 of body 182. Such a configuration may be used to provide a two step filtration in one module, whereas a pre-filtration is provided by the sheet material of the outer cylindrical portion 185 of body 182. The fluid filtered therein is collected in the treatment channels 198 is then filtered in a second step through the sheet material of the inner cylindrical portion 187 of body 182 and collected in the outlet channels 194 from where it flows to the passage 206.

By providing the inlet channels 190 and the outlet channels 194 in the same disk shaped portions of the body 182, a very much compact structure of the module is made possible.

It goes without saying that the treatment channels 198 may be filled with treatment material as will be discussed in some more detail below.

In case the treatment channels 198 are filled with a treatment material, three different processes may be performed upon one passing of the fluid through module 180, namely

a pre-filtration in the course of passing the fluid from the inlet channels 190 to the treatment channels 198,
a treatment of the fluid when passing through the treatment channels 198 and
a second filtration step when passing the fluid from the treatment channels 198 to the outlet channels 194.

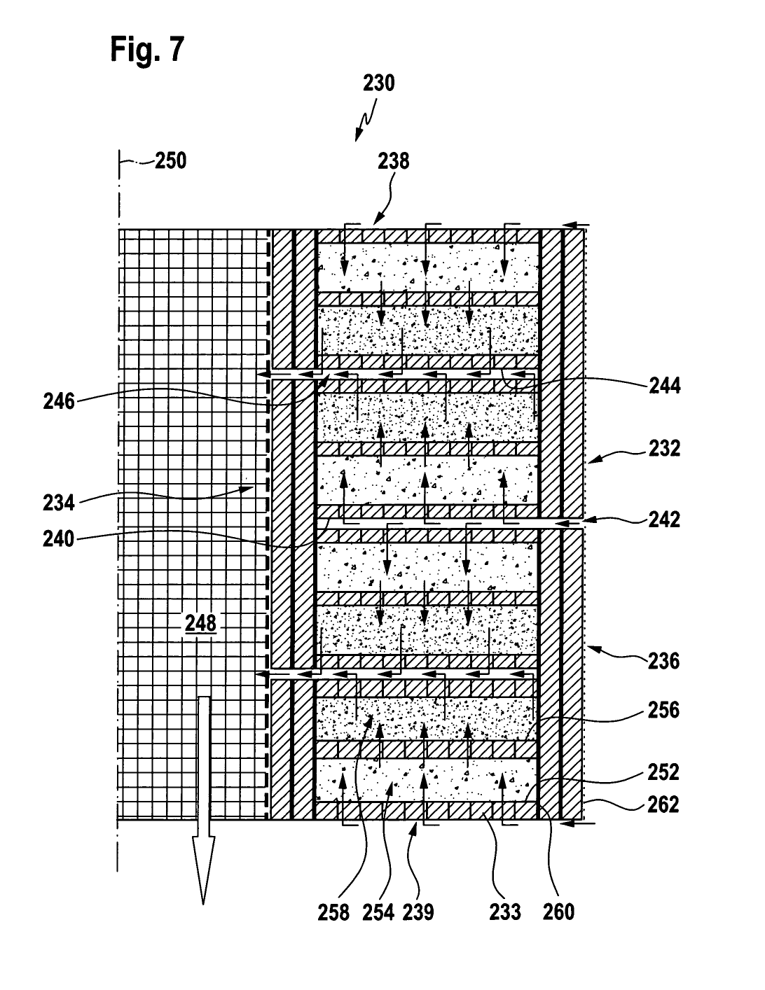

It is readily understood from this explanation that if further treatment channels 198 would have been provided and the outlet channels 194 would have been arranged in a section of the module which is different from the section accommodating the inlet channels even more steps could be performed in one pass of the fluid through module 180 (cf. description of FIG. 7).

By having the end portions 210 and 212 provided with tapered sections (not shown), a smooth winding of the sheet material is provided which contributes to a full contact of adjacent layers of sheet material throughout the body 182.

The tapered portion of end portion 212 of the sheet material at the outer peripheral surface 204 of body 182 provides for a smooth outer surface, avoiding step-like recesses on that surface.

This is of importance, once the body 182 of the filter module 180 is hold in compression by strip-like elements 214 which serve to keep the sheet material of body 182, and therefore the body 182 as a whole, in a compressed state such that bypasses from inlet channels 190 to treatment and outlet channels 194 are avoided.

The strip-like elements 214 function as compression means and are positioned on the outer peripheral surface 204 of body 182 on such disk shaped portions 216 of the body 182 which comprise the treatment channels 198. The portion 218 of the body 182 comprising the inlet and outlet channels 190 and 194 are not covered by these strip-like elements 214. Therefore the compression of the body 182 in the areas 216 comprising the treatment channels 198 is somewhat higher than in the portions 218 of body 182 accommodating the inlet and outlet channels 190, 194.

A tapered end of the end portion 212 of the sheet material helps to apply the compression force of the strip-like elements 214 around the whole outer peripheral surface 204 in an even fashion which makes sure that the body 182 has homogenous filter characteristics throughout the whole body.

The sheet material of body 182 may be a depth filter material or may be a non-porous material depending on whether the module is to work as a depth filter unit or a surface filter unit or a treatment module.

Most of the depth filter materials useful in the present invention may be compressed or deformed. The portion of deformation, which is permanent, differs depending on the depth filter material used.

Preferably, the depth filter material is not only plastically or permanently deformable, but at least partly shows elastic properties so that upon compression of the sheet material, the elastic portion of the deformation helps to keep the adjacent layers of sheet material in close contact with one another, even if the surface of the sheet material may in its original state not be perfectly planar.

FIG. 7 shows an embodiment of the present invention where a module 230 comprises two types of treatment channels which are passed by the fluid to be processed in sequence prior to have the fluid exiting into outlet channels. The structure of the module 230 shown in FIG. 7 will be now described in more detail.

Module 230 comprises a body 232 which is essentially made of a plurality of windings of a sheet material 233 providing a cylindrical structure with an inner peripheral surface 234 and an outer peripheral surface 236 as well as end faces 238, 239.

The sheet material 233 comprises openings 240 which register with corresponding openings of subsequent layers to form inlet channels 242.

The sheet material further provides openings 244 which register with corresponding openings of subsequent layers of sheet material 233 to form outlet channels 246.

Whereas the inlet channels 242 are open at their one end towards the outer peripheral surface 236, the outlet channels are open at one end towards the inner peripheral surface 234 and communicate with a passage 248 extending along a winding axis 250 from one end face 238 to the other end face 239 of the body 232.

The sheet material 233 further comprises two other types of openings 252, 256 which register with corresponding openings of subsequent winding layers of the sheet material 233 to form a first type of treatment channel 254 and a second type of treatment channel 258, respectively.

While the inlet channels 242 are closed at their one end directed towards the inner peripheral surface 234 and the outlet channels 246 are closed at their one end directed to the outer peripheral surface 236, the first and second type of treatment channels 254 and 258 are closed at both ends thereof, i.e., towards the inner peripheral surface 234 and towards the outer peripheral surface 236.

Because of the arrangement of the openings 252 and 256 side by side in axial direction and the next two groups of openings 252 and 256 being separated by a line of openings 244 forming outlet channels 246 and/or openings 240 forming inlet channels 242, a flow pattern for the fluid to be treated is obtained as demonstrated by the arrows in FIG. 7. Inflowing fluid passes through a first portion of sheet material either via the end faces 238, 239 or through portions of sheet material adjacent to the surfaces of inlet channels 242 and arrive in a first treatment channel 254 where the fluid is collected and passes on through a further portion of sheet material 233 and enters a second treatment channel 258 where the fluid again is collected. From treatment channels 258 the fluid passes through an other portion of sheet material 233 and is collected in the outlet channels 246 and exits the module 230 through passage 248.

It is understood that the treatment channels 254 and 258 are separate from one another and therefore may accommodate the same or different types of treatment material or one treatment channel may be free from treatment material, the other one may be filled with treatment material.

It is easily understood that the number of different treatment channels may be even increased to have the fluid pass through an even larger number of treatment channels until it is collected in outlet channels 246 and passed on to passage 248.

It is noted, however, that the structure provided by the module 230 represented in FIG. 7 already provides a very large versatility as to processing applications for fluids which may be even increased by a selection of various sheet material 233.

As noted above, the end portions of the treatment channels 254, 258 as well as one of the ends of inlet and outlet channels 242, 246 are closed in order to achieve the desired fluid flow pattern. In order to securely close the respective ends of the different channels 242, 246, 254 and 258 at the inner peripheral surface 234 and at the outer peripheral surface 236, two layers of sheet material are provided which lack the respective openings 240, 244, 252 and 256.

In order to further ensure that no bypasses occur and that the fluid flow pattern exactly corresponds to what is necessary for a specific fluid processing application, the windings of sheet material 233 may include in the innermost and outermost portion of body 232 additional safety layers 260 which may be made of a fluid impervious material or of a material with a higher fluid flow resistance in radial direction then is observed with the sheet material 233.

On the outer peripheral surface 236 a compressing sheet 262 may be used which may of a grid like open structure so as to cover most of the outer peripheral surface 236 without obstructing fluid flow from the outer peripheral surface into the inlet channels 232.

The preferable depth filter material used according to the present invention for providing modules for filtration applications may have different basic structures. For example, nonwoven fiber material may be used on the basis of melt blown fibers, cellulosic fibers or other naturally occurring fibers, organic or inorganic fibers, metal fibers, glass fibers, ceramic fibers, etc.

Also woven materials are possible with various fiber structures. The woven material may be monofil material, multifil material and/or multilayer material The basic materials may be cellulosic material, or other naturally occurring fibers, organic or inorganic fibers, the latter including metal fibers.

Also sintered materials may be a suitable depth filter material for use as sheet material including sintered woven materials, sintered powder materials of different structure and particle sizes, mainly made of plastic or metal.

Furthermore, foamed material of plastic or naturally occurring polymers of different structure may constitute a sheet material useful in the present invention.

Depth filter materials manufactured of the basis of cellulosic fibers may be compressed substantially, i.e., very well below about 20% of their original thickness without destroying integrity of the filter layers. The degree of maximal compression of course depends on the presence or absence of additives combined with the cellulosic fibers. Such additives may very well be incompressible and may occur in amounts of up to about 70% by weight, based on the weight of the sheet material.

Cellulose based sheet materials are well suited for the present invention. They may be compressed to a thickness of, e.g., about 12% of the original thickness, using a compression force of 2700 N. When those materials are allowed to recover a thickness of about 20% of the original thickness, the elastic force amounts, e.g., to 530 N.

Other examples of useful cellulose based sheet materials, which may be used according to the present invention as sheet material to form the body 12 may be compressed to a thickness of about 33% with a compression force of 3600 N and show a elastic force when released to a thickness of about 45% of its original thickness of 250 N.

Cellulosic material usually swells when contacted with aqueous media and in the latter example, the elastic force may be increased by the swelling effect to 310 N.

In an application where the sheet material forming body will not swell in contact with the fluid to be filtered, a somewhat higher compression will usually be used than in cases where the sheet material swells when in contact with the fluid to be filtered. This is often sufficient to ensure a safe operation of the filter module.

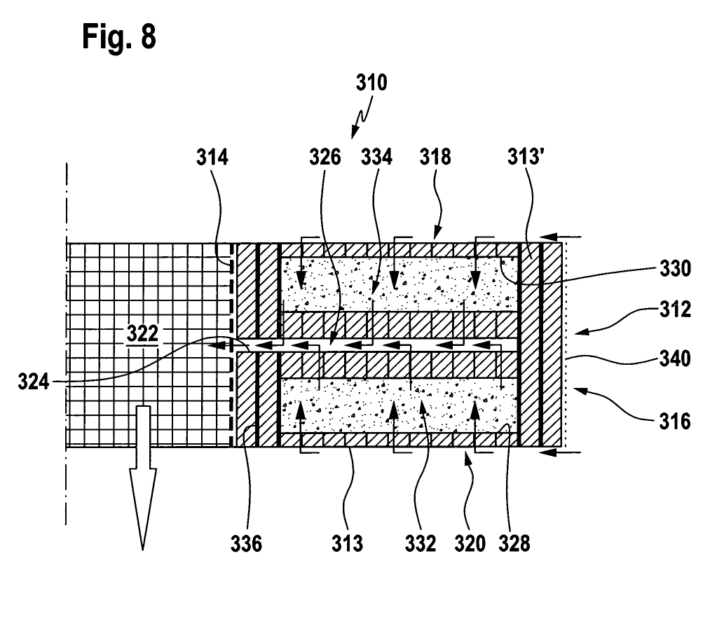

FIG. 8 provides a representation of a module 310 with the most simple design according to the present invention.

Module 310 comprises a body 312 of wound sheet material 313. The body 312 has an inner peripheral surface 314 and an outer peripheral surface 316 as well as end faces 318, 320.

The inner peripheral surface 314 defines a passage 322 which extends in axial direction through the whole of body 312. The sheet material 313 constituting the inner peripheral surface 314 of body 312 has only one type of openings 324 which are arranged in a single row and which are to provide outlet channels 326. The innermost two layers of sheet material 313 are only provided with this type of opening 324.

In the following windings of sheet material 313, further openings 328, 330 are provided which are to form treatment channels 332, 334. The outermost portion of sheet material 313′ does not comprise any sort of openings and covers the outer ends of the treatment channels 332 and 334 as well as of outlet channels 326.

In this configuration of an inventive module, the end faces 318, 320 are providing essentially all of the surface area for fluid ingress into the body 312 of module 310.

The fluid passes then through portions of the sheet material 313 into the treatment channels 332, 334 where it is collected and then penetrates portions of the sheet material 313 to be collected in outlet channels 326.

These outlet channels 326 are open at their end directed towards the inner peripheral surface 314 and are drained by passage 322.

If need be, the innermost layers of sheet material 313 as well as the outermost layers of sheet material 313 may be accompanied by a security layer material 336 which may be fluid impervious or of a higher fluid flow resistance than the sheet material 313 in radial direction.

It is noted here that the openings 328 and 330 may each form a continuous ring-shaped channel 332 and 334, respectively, extending all around passage 322.

Further, on the outer peripheral surface of body 312 a clamping means in the form of a strip-like material 340 may be applied in order to compress the sheet material 313 in its wound configuration and provide a tight contact of each of the layers of sheet material 313 within body 312 in order to avoid bypass problems.

1. A fluid processing system comprising a housing and at least one of a first type module and at least one of a second type module, said first and second type modules each comprising a body of wound layers of a sheet material,
said body having an inner and an outer peripheral surface, a first and a second end face, a winding axis and a passage extending along the winding axis of said body and in fluid communication with said inner peripheral surface, the passage of one of the first type and one of the second type modules being closed at one end thereof,
said sheet material having a plurality of openings formed therein,
said openings forming at least a first and a second type of channels within the wound layers of sheet material of said body,
said channels extending in a direction from the inner peripheral surface to the outer peripheral surface,
the first type of channels being open at one end at said outer or said inner peripheral surface of the body and closed at the other end located adjacent to said inner peripheral or outer peripheral surface,
the second type of channels being open and closed at the respective other ends or closed at both ends thereof,
said channels of the one type being separated from the channels of the other type by portions of sheet material,
the first and second modules having different fluid processing characteristics,
said housing having an inlet port and an outlet port and accommodating said first and second modules,
the inlet port of the housing being in fluid communication with the end faces and/or one type of channels of the first type modules serving as inlet channels,
the outlet port of the housing being in fluid communication with the end faces and/or one type of channels of the second type modules serving as outlet channels.

2. The system of claim 1, wherein said housing comprises at least one compartment to accommodate the first and second modules.

3. The system of claim 2, wherein said first and second modules share one common compartment.

4. The system of claim 1, wherein the system comprises at least one third module, said third module comprising a body of wound layers of a sheet material, the third module having processing characteristics which differ from the processing characteristics of the first and second modules, the passage of the third module being closed at one end thereof,
said third module being encased in a fluid tight casing having an inlet and an outlet communicating with the inlet and outlet channels of the body of the third filter module, respectively.

5. The system of claim 4, wherein the inlet of the casing of the third module is in fluid communication with the outlet channels of the second module and wherein the outlet of the casing of the third module is in fluid communication with said outlet port.

6. The system of claim 4, wherein the inlet of the casing of the third module is in fluid communication with said inlet port and wherein the outlet of the casing of the third module is in fluid communication with inlet channels of the first module.

7. The system of claim 1, wherein the housing comprises separate compartments for each type of module, said compartments being separated from one another by a partition plate.

8. The system of claim 7, wherein the partition plate is positioned perpendicular to the winding axis of the modules.

9. The system of claim 1, wherein the housing accommodates at least one deflection plate which provides a fluid flow connection from the exterior area of a module to the interior area of an adjoining module wherein the interior area is the area of the module surrounding the central channel and the exterior area is the area of the module separated from the interior area by a filter material.

10. The system of claim 1, wherein at least one intermediate plate within the housing is provided in between two modules which extends transversely to the longitudinal axis of the central channel.

11. The system of claim 1, wherein the modules are stacked within the housing, the passages of the modules being in line with a central axis of the housing.

12. The system of claim 11, wherein a top plate is provided which is arranged on top of the stack of modules and the top plate comprises an opening.

13. The system of claim 1, wherein an adapter plate is arranged at the bottom of the stack of modules and has a central opening which opens into an opening provided in the housing bottom.

14. The system of claim 1, wherein the one type of modules are filter modules in direct fluid communication with the inlet port and serve as a pre-filter.

15. The system of claim 1, wherein the modules of each type share a common compartment.

16. The system of claim 1, wherein each module is accommodated in a separate compartment.

17. The system of claim 1, wherein the system comprises more than two different types of modules.

18. The system of claim 1, wherein the sheet material of the first and second type modules have different processing characteristics.

19. The system of claim 1, wherein the sheet material of the first and second type modules is compressible and is comprised in the bodies of wound layers of sheet material in a different state of compression.

20. The system of claim 1, wherein the sheet material is a porous sheet material.

21. The system of claim 20, wherein the porous sheet material is a depth filter material.

22. The system of claim 21, wherein at least one of the first and second type modules includes a pre-coating.

23. The system of claim 1, wherein at least one type of modules is made of a sheet material where the openings form two types of channels, one type of channels being open at the inner peripheral surface of the body and closed at its end towards the outer peripheral surface and the other type of channels is open at the outer peripheral surface and closed at its end towards the inner peripheral surface.

24. The system of claim 1, wherein at least one type of modules is made of a sheet material where the openings form two types of channels, one type of channels being open at the inner peripheral surface of the body and closed at the end towards the outer peripheral surface of the body and the other type of channels being closed at both ends thereof,
the one type of channels forming outlet channels and the end faces of the body allowing fluid ingress into the body and the other type of channels,
or the one type of channels forming inlet channels and the end faces of the body serve to drain fluid from the other type of channels.

25. The system of claim 1, wherein at least one type of modules is made of a sheet material where
said openings form at least first, second, and third types of channels within the wound layers of sheet material of said body,
said channels extend in a direction from the inner peripheral surface to the outer peripheral surface,
the first type of channel(s) being open at one end at said outer peripheral surface of the body and closed at the other end located adjacent to said inner peripheral surface,
the second type of channel(s) being open at one end at said inner peripheral surface of the body, in fluid communication with said passage and closed at the other end located adjacent to said outer peripheral surface,
the third type of channel(s) being closed at both ends thereof, said channel(s) of the third type being positioned in said body such as to receive fluid from one or more channels of the first or second type, whereas one or more channels of the other one of the first and second type of channels receives fluid from the third type of channels.

26. The system of claim 1, wherein in at least one type of modules at least one type of channels is provided in the form of a continuous ring-shaped cavity.

27. The system of claim 1, wherein in at least one type of modules at least one type of channels is provided with both ends thereof closed, said channels accommodating a particulate treatment agent, selected from filter aids, adsorption material, absorption material, reagents and catalytic components.

28. A method of processing a fluid using a fluid processing system comprising a housing and at least one of a first type module and at least one of a second type module, said first and second type modules each comprising a body of wound layers of a sheet material,
said body having an inner and an outer peripheral surface, a first and a second end face, a winding axis and a passage extending along the winding axis of said body and in fluid communication with said inner peripheral surface, the passage of one of the first type and one of the second type modules being closed at one end thereof,
said sheet material having a plurality of openings formed therein,
said openings forming at least a first and a second type of channels within the wound layers of sheet material of said body,
said channels extending in a direction from the inner peripheral surface to the outer peripheral surface,
the first type of channels being open at one end at said outer or said inner peripheral surface of the body and closed at the other end located adjacent to said inner peripheral or outer peripheral surface,
the second type of channels being open and closed at the respective other ends or closed at both ends thereof,
said channels of the one type being separated from the channels of the other type by portions of sheet material,
the first and second modules having different fluid processing characteristics,
said housing having an inlet port and an outlet port and accommodating said first and second modules,
the inlet port of the housing being in fluid communication with the end faces and/or one type of channels of the first type modules serving as inlet channels,
the outlet port of the housing being in fluid communication with the end faces and/or one type of channels of the second type modules serving as outlet channels,
comprising supplying a fluid to the inlet port of the housing and discharging a filtrate from the outlet port of the housing.

29. The method of claim 28, comprising coarse filtration and fine filtration of the fluid.

30. The method of claim 28, comprising filtration and stabilization treatment of the fluid.

31. The method of claim 28, wherein processing the fluid comprises any one or more of redox treatment, pH-adjustment, ion-exchange, catalytic reaction, adsorption and absorption.
